(19) United States
(12) Patent Application Publication
(10) Pub. No.: US 2026/0351245 A1
(43) Pub. Date: Nov. 5, 2026

(54) MODEL TRAINING METHOD AND APPARATUS, AND SPEECH MEANING UNDERSTANDING METHOD AND APPARATUS

(71) Applicant: Alipay (Hangzhou) Information Technology Co., Ltd., Hangzhou (CN)

(72) Inventors: Lanqing XUE, Hangzhou (CN); Zhenzhe YING, Hangzhou (CN); Jinzhen LIN, Hangzhou (CN); Xiaofeng WU, Hangzhou (CN)

(21) Appl. No.: 18/868,063

(22) PCT Filed: May 10, 2023
(86) PCT No.: PCT/CN2023/093289

§ 371 Date: Apr. 6, 2026

(30) Foreign Application Priority Data
May 23, 2022 (CN) 202210561117.1

(51) Int. Cl. G10L 15/06; G06F 40/279; G06F 40/30; G10L 15/01; G10L 15/26

(52) U.S. Cl. CPC G10L 15/063; G06F 40/279; G06F 40/30; G10L 15/01; G10L 15/26

(57) ABSTRACT

Embodiments of this specification provide a training method and apparatus for a fuzzy pinyin recognition model, and a speech meaning understanding method and apparatus. The training method includes: obtaining a sample text with semantics that includes a plurality of characters; obtaining pinyin of each character in the sample text; obtaining fuzzy pinyin corresponding to each character based on the pinyin of each character in the sample text; and training the fuzzy pinyin recognition model based on the sample text, the fuzzy pinyin corresponding to each character in the sample text, and a label of the sample text.

### TECHNICAL FIELD

This application relates to electronic information technologies, and in particular, to a training method and apparatus for a fuzzy pinyin recognition model, and a speech meaning understanding method and apparatus.

### BACKGROUND

Currently, a speech recognition technology is widely applied. When the speech recognition technology is applied, a speech spoken by a user is usually first recognized, the speech is converted into a text, and a meaning of the text is understood, to obtain a meaning of the speech and perform related processing.

However, a current speech recognition technology is immature. When a speech is converted into a text, a recognition error frequently occurs. A meaning of the speech cannot be accurately understood based on an incorrect text.

### SUMMARY

One or more embodiments of this specification describe a training method and apparatus for a fuzzy pinyin recognition model, and a speech meaning understanding method and apparatus, so that a meaning of a speech can be more accurately understood.

According to a first aspect, a training method for a fuzzy pinyin recognition model is provided, including: obtaining a sample text with semantics that includes a plurality of characters; obtaining pinyin of each character in the sample text; obtaining fuzzy pinyin corresponding to each character based on the pinyin of each character in the sample text; and training the fuzzy pinyin recognition model based on the sample text, the fuzzy pinyin corresponding to each character in the sample text, and a label of the sample text.

Obtaining fuzzy pinyin corresponding to each character based on the pinyin of each character in the sample text includes: for the pinyin of each character in the sample text, determining whether the pinyin includes a first pronunciation, where the first pronunciation satisfies that a second pronunciation is confused with the first pronunciation; and if no, directly using the pinyin as the fuzzy pinyin corresponding to the character; or if yes, replacing the first pronunciation in the pinyin with the second pronunciation, and using pinyin obtained through replacement as the fuzzy pinyin corresponding to the character.

Obtaining fuzzy pinyin corresponding to each character based on the pinyin of each character in the sample text includes: splitting the pinyin of each character in the sample text into an initial and a final; for the initial obtained through splitting, determining whether the initial includes a first pronunciation; and if no, directly using the initial as fuzzy pinyin corresponding to the initial of the character; or if yes, replacing the first pronunciation in the initial with a second pronunciation corresponding to the first pronunciation, to obtain fuzzy pinyin corresponding to the initial of the character; and for the final obtained through splitting, determining whether the final includes a first pronunciation; and if no, directly using the final as fuzzy pinyin corresponding to the final of the character; or if yes, replacing the first pronunciation in the final with a second pronunciation corresponding to the first pronunciation, to obtain fuzzy pinyin corresponding to the final of the character.

For the final obtained through splitting, before determining whether the final includes a first pronunciation, the method further includes: determining whether the final includes a head vowel and a tail vowel, and if yes, deleting the head vowel from the final; and determining whether the final includes a first pronunciation includes: determining whether a final after the head vowel is deleted includes a first pronunciation.

Training the fuzzy pinyin recognition model includes: generating a triplet corresponding to each character in the sample text, where the triplet includes the character, the fuzzy pinyin corresponding to the initial of the character, and the fuzzy pinyin corresponding to the final of the character; and successively inputting triplets corresponding to all the characters and the label into the to-be-trained fuzzy pinyin recognition model in a sequence of all the characters in the sample text.

The label of the sample text includes a label given in at least one of an emotion dimension, a field dimension, a subject matter dimension, and a text meaning dimension.

According to a second aspect, a speech meaning understanding method is provided, including: obtaining a first text, where the first text is generated by performing speech recognition on a speech; obtaining pinyin of each character in the first text; obtaining fuzzy pinyin corresponding to each character based on the pinyin of each character; inputting the first text and the fuzzy pinyin corresponding to each character in the first text into a fuzzy pinyin recognition model, to obtain a second text output by the fuzzy pinyin recognition model; and understanding the second text, to obtain a meaning of the speech.

Obtaining fuzzy pinyin corresponding to each character based on the pinyin of each character includes: for the pinyin of each character in the first text, determining whether the pinyin includes a first pronunciation, where the first pronunciation satisfies that a second pronunciation is confused with the first pronunciation; and if no, directly using the pinyin as the fuzzy pinyin corresponding to the character; or if yes, replacing the first pronunciation in the pinyin with the second pronunciation, and using pinyin obtained through replacement as the fuzzy pinyin corresponding to the character.

Obtaining fuzzy pinyin corresponding to each character based on the pinyin of each character includes: splitting the pinyin of each character in the first text into an initial and a final; for the initial obtained through splitting, determining whether the initial includes a first pronunciation; and if no, directly using the initial as fuzzy pinyin corresponding to the initial of the character; or if yes, replacing the first pronunciation in the initial with a second pronunciation corresponding to the first pronunciation, to obtain fuzzy pinyin corresponding to the initial of the character; and for the final obtained through splitting, determining whether the final includes a first pronunciation; and if no, directly using the final as fuzzy pinyin corresponding to the final of the character; or if yes, replacing the first pronunciation in the final with a second pronunciation corresponding to the first pronunciation, to obtain fuzzy pinyin corresponding to the final of the character.

For the final obtained through splitting, before determining whether the final includes a first pronunciation, the method further includes: determining whether the final includes a head vowel and a tail vowel, and if yes, deleting the head vowel from the final; and determining whether the final includes a first pronunciation includes: determining whether a final after the head vowel is deleted includes a first pronunciation.

Inputting the first text and the fuzzy pinyin corresponding to each character in the first text into a fuzzy pinyin recognition model includes: generating a triplet corresponding to each character in the first text, where the triplet includes the character, the fuzzy pinyin corresponding to the initial of the character, and the fuzzy pinyin corresponding to the final of the character; and successively inputting triplets corresponding to all the characters into the fuzzy pinyin recognition model in a sequence of all the characters in the first text.

According to a third aspect, a training apparatus for a fuzzy pinyin recognition model is provided, including: a sample text obtaining module, configured to obtain a sample text with semantics that includes a plurality of characters; a pinyin obtaining module, configured to obtain pinyin of each character in the sample text; a fuzzy pinyin generation module, configured to obtain fuzzy pinyin corresponding to each character based on the pinyin of each character in the sample text; and a training execution module, configured to train the fuzzy pinyin recognition model based on the sample text, the fuzzy pinyin corresponding to each character in the sample text, and a label of the sample text.

According to a fourth aspect, a speech meaning understanding apparatus is provided, including: a speech recognition result receiving module, configured to obtain a first text, where the first text is generated by performing speech recognition on a speech; a character pinyin generation module, configured to obtain pinyin of each character in the sample text; a character fuzzy pinyin generation module, configured to obtain fuzzy pinyin corresponding to each character based on the pinyin of each character; an input module, configured to input the first text and the fuzzy pinyin corresponding to each character in the first text into a fuzzy pinyin recognition model, to obtain a second text output by the fuzzy pinyin recognition model; and a speech meaning understanding module, configured to understand the second text, to obtain a meaning of the speech.

According to a fifth aspect, a computing device is provided, and includes a memory and a processor. The memory stores executable code, and when the processor executes the executable code, the method according to any embodiment of this specification is implemented.

According to the embodiments of this specification, a fuzzy pinyin recognition model that can correct a word error of speech recognition can be trained, and a meaning of a speech can be more accurately understood based on the model.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show some embodiments of this specification, and a person of ordinary skill in the art can still derive other drawings from these accompanying drawings without creative efforts.

FIG. 1 is a flowchart illustrating a training method for a fuzzy pinyin recognition model, according to an embodiment of this specification;

FIG. 2 is a flowchart illustrating a speech meaning understanding method, according to an embodiment of this specification;

FIG. 3 is a schematic structural diagram illustrating a training apparatus for a fuzzy pinyin recognition model, according to an embodiment of this specification; and

FIG. 4 is a schematic structural diagram illustrating a speech meaning understanding apparatus, according to an embodiment of this specification.

### DESCRIPTION OF EMBODIMENTS

As mentioned above, currently, when a speech is converted into a text, a recognition error frequently occurs. A meaning that is to be expressed by the speech cannot be accurately understood based on an incorrect text. For example, an intelligent customer service system implemented by a machine asks a user: Did you buy a physical item or a virtual item? The user replies with a speech. The user originally wants to reply with the physical item. However, because the user uses a dialect, a speech recognition error is caused. A recognized text is “ [symbol] [symbol] ”. Consequently, the intelligent customer service system cannot understand, based on the recognized incorrect text, a meaning that is to be expressed by the speech of the user, to cause a service error.

The solutions provided in this specification are described below with reference to the accompanying drawings.

It can be learned, by analyzing a speech recognition process, that an important reason for a speech recognition error is that a pronunciation of a speech of a user is not standard. People in different regions may use different dialects, to confuse one pronunciation with another pronunciation. For example, a flat-tongue initial is confused with a curled-tongue initial. In some places, “z, c, s” in pinyin is pronounced as “zh, ch, sh”. For example, “ [symbol] ” is pronounced as “zhi xing che”. For another example, people in some places pronounce “j, q, x” in pinyin as “z, c, s”, for example, pronounce “ [symbol] ” as “zin siu”. For still another example, people in some places confuse pronunciations of “f” and “h” in pinyin, for example, pronounce “ [symbol] ” as “huǎn dui”.

Therefore, if a pronunciation of each character in a text recognized from a speech can be corrected based on a pronunciation confusion feature, a problem that a speech recognition error is caused because a pronunciation of the user is not standard can be effectively resolved.

To correct the speech recognition error based on the pronunciation confusion feature, in an embodiment of this specification, a fuzzy pinyin recognition model can be pre-trained. In an actual service application, the fuzzy pinyin recognition model can be used to correct the text recognized from the speech, to more correctly understand a meaning of the speech.

A method in the embodiments of this specification can be applied to various speech recognition application scenarios. For example, Scenario 1 to Scenario 3 are included.

### Scenario 1: Intelligent Customer Service System

After a user enters a speech through a telephone or a network, the intelligent customer service system (for example, a machine customer service on an Alipay platform) performs speech recognition, to recognize a text. A fuzzy pinyin recognition model and a speech meaning understanding method provided in the embodiments of this specification are applied, so that an error in the text recognized from the speech can be corrected, to obtain a correct text that better satisfies a user intention. In this way, a machine can more correctly understand a meaning of the speech of the user, for example, whether the user buys a physical item or a virtual item, or whether an item needs to be returned or exchanged.

### Scenario 2: Artificial Intelligence System

After a user sends a speech through a live dialogue, a telephone, or a network, the artificial intelligence system (for example, a robot) performs speech recognition, to recognize a text. A fuzzy pinyin recognition model and a speech meaning understanding method provided in the embodiments of this specification are applied, so that the artificial intelligence system (for example, the robot) can correct an error in the text recognized from the speech, to obtain a correct text that better satisfies a user intention. In this way, a machine can more correctly understand a meaning of the speech of the user. For example, the robot is commanded to change a walking route.

### Scenario 3: Smart Home System Based on an Internet of Things

After a user sends a speech through a live dialogue, a telephone, or a network, the smart home system (for example, a smart television) performs speech recognition, to recognize a text. A fuzzy pinyin recognition model and a speech meaning understanding method provided in the embodiments of this specification are applied, so that the smart home system (for example, the smart television) can correct an error in the text recognized from the speech, to obtain a correct text that better satisfies a user intention. In this way, a machine can more correctly understand a meaning of the speech of the user. For example, the smart television is commanded to be powered on to record a television program at a specific moment.

The following describes implementations of the embodiments in this specification in two aspects. A training method for a fuzzy pinyin recognition model is described in a first aspect, and a speech meaning understanding method is described in a second aspect.

First, the training method for a fuzzy pinyin recognition model is described in the first aspect.

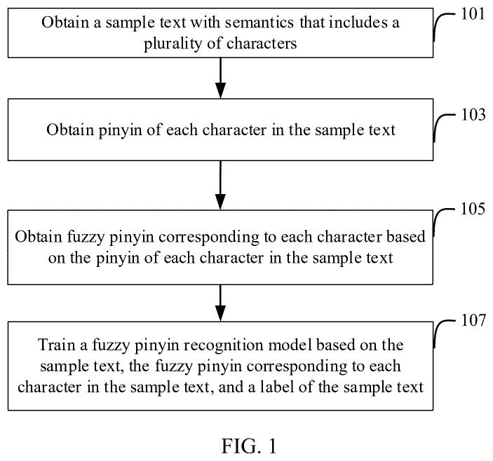

FIG. 1 is a flowchart illustrating a training method for a fuzzy pinyin recognition model, according to an embodiment of this specification. The method is performed by a training apparatus for a fuzzy pinyin recognition model. It can be understood that the method can alternatively be performed by any apparatus, device, platform, or device cluster having computing and processing capabilities. As shown in FIG. 1, the method includes: Step 101: Obtain a sample text with semantics that includes a plurality of characters. Step 103: Obtain pinyin of each character in the sample text. Step 105: Obtain fuzzy pinyin corresponding to each character based on the pinyin of each character in the sample text. Step 107: Train the fuzzy pinyin recognition model based on the sample text, the fuzzy pinyin corresponding to each character in the sample text, and a label of the sample text.

It can be learned that, in the above-mentioned process shown in FIG. 1, when the fuzzy pinyin recognition model is trained, in consideration that a pronunciation of a user is not standard, a pronunciation of a character such as a Chinese character is confused with a pronunciation of another Chinese character. Therefore, a concept of the fuzzy pinyin is designed. In this way, regardless of an accent or a pronunciation manner used by the user, two characters confused due to different pronunciations can be uniformly pronounced as the same fuzzy pinyin based on the fuzzy pinyin, so that the fuzzy pinyin recognition model learns of a pronunciation manner of a character pronounced in a confused manner, and obtains a correct character with reference to a context of the sample text. In this way, the fuzzy pinyin recognition model can be used to subsequently correct an error in a text recognized from a speech.

The following separately describes all steps shown in FIG. 1 with reference to a specific example.

First, in step 101, the sample text with semantics that includes a plurality of characters is obtained.

The sample text is required for training the fuzzy pinyin recognition model. The sample text can be any type of text with semantics, for example, an article, a paragraph of user complaint text, or a paragraph of product description text. To enable the fuzzy pinyin recognition model to learn of various cases of a pronunciation error and a corresponding character error that are caused by a user accent, the sample text needs to include at least one character formed through non-standard pronunciation (user accent or dialect). For example, the sample text includes “ . . . [symbol] . . . , . . . [symbol] ”. Because of the user accent, “zi” of “ [symbol] ” in “ [symbol] [symbol] ” is pronounced as “zhi”, and “zhi” corresponds to “ [symbol] ” that is a character formed through non-standard pronunciation. In addition, because of the user accent, “nu” of “ [symbol] ” in “ [symbol] ” is pronounced as “lu”, and “lu” corresponds to “ [symbol] ” that is a character formed through non-standard pronunciation.

In this embodiment of this specification, the character can include at least one of a Chinese character, an English letter, or a punctuation mark.

In this embodiment of this specification, the sample text has the label, and the label can be a label given in at least one of an emotion dimension, a field dimension, a subject matter dimension, and a text meaning dimension. For example, the label represents that an emotion expressed by the sample text is anger, the label represents that the sample text belongs to the user complaint field, and the label represents that a meaning of the sample text is that the user buys a physical item, etc., so that the fuzzy pinyin recognition model learns, based on the label, of whether each character in the sample text and the fuzzy pinyin of the character are correct.

Next, in step 103, the pinyin of each character in the sample text is obtained.

Here, standard pinyin of each character can be obtained from a dictionary.

For example, the sample text includes “ . . . [symbol] . . . , . . . [symbol] ”. In step 103, pinyin “zhi” of the character “ [symbol] ” is obtained, pinyin “xing” of the character “ [symbol] ” is obtained, pinyin “che” of the character “ [symbol] ” is obtained, and pinyin “lu” of the character “ [symbol] ” is obtained.

Next, in step 105, the fuzzy pinyin corresponding to each character is obtained based on the pinyin of each character in the sample text.

In this embodiment of this specification, the concept of the fuzzy pinyin is designed. Fuzzy pinyin corresponding to pinyin of a character satisfies that the pinyin is the same as the fuzzy pinyin when a pronunciation of the pinyin does not include a first pronunciation that is easily confused; or a pronunciation of the pinyin is confused with a pronunciation of the fuzzy pinyin when the pronunciation of the pinyin includes a first pronunciation. In this way, regardless of an accent or a pronunciation manner used by the user, two characters confused due to different pronunciations can be uniformly pronounced as the same fuzzy pinyin based on the fuzzy pinyin, so that the fuzzy pinyin recognition model learns of a pronunciation manner of a character pronounced in a confused manner.

As described above, due to the user accent or the dialect, the user usually confuses one pronunciation with another pronunciation, for example, confuses pronunciations of “z, c, s” with pronunciations of “zh, ch, sh”, confuses a pronunciation of “ing” with a pronunciation of “in”, and confuses a pronunciation of “f” with a pronunciation of “h”. Therefore, a correspondence between a first pronunciation and a second pronunciation that are confused with each other can be preset, to determine a specific pair of pronunciations that are confused with each other. For example, the correspondence between the first pronunciation and the second pronunciation is recorded in Table 1.

TABLE 1

| First pronunciation | Second pronunciation |
|---|---|
| zh | z |
| ch | c |
| sh | s |
| l | n |
| h | f |
| in | ing |
| en | eng |
| an | ang |

In Table 1, the first pronunciation is usually a pronunciation made by a user that has an accent or uses a dialect, and the second pronunciation is an original pronunciation of a character. It can be understood that Table 1 is merely an example. In an actual service, different correspondences between a first pronunciation and a second pronunciation can be set based on different application locations, namely, different user accent characteristics. After the correspondence shown in Table 1 is set, the fuzzy pinyin of the pinyin of the character in the sample text can be replaced based on the correspondence.

Step 105 includes the following two implementations. In Manner 1, the fuzzy pinyin of the pinyin is replaced in a unit of one pinyin syllable. In Manner 2, the fuzzy pinyin of the pinyin is replaced separately in a unit of an initial and a unit of a final.

Manner 1 is first described. In an embodiment of this specification, a specific implementation process of step 105 based on Manner 1 includes: Step 1051A: For the pinyin of each character in the sample text, determine whether the pinyin includes a first pronunciation, where the first pronunciation satisfies that a second pronunciation is confused with the first pronunciation; and perform step 1053A if yes; or perform step 1055A if no.

Step 1053A: Directly use the pinyin as the fuzzy pinyin corresponding to the character.

Step 1055A: Replace the first pronunciation in the pinyin with the second pronunciation, and use pinyin obtained through replacement as the fuzzy pinyin corresponding to the character.

The above-mentioned process of step 1051A to step 1055A is described by using an example. For example, in step 103, for all the characters “ . . . [symbol] . . . , . . . [symbol] ” included in the sample text, pinyin “zhi”, “xing”, “che”, and “lu” corresponding to all the characters are separately obtained. In this way, in the process of step 1051A to step 1055A, for pinyin “zhi” of the character “ [symbol] ”, because the pinyin “zhi” includes one first pronunciation “zh” in Table 1, the first pronunciation “zh” in the pinyin is replaced with the second pronunciation “z” corresponding to the first pronunciation “zh”, and pinyin “zi” obtained through replacement is used as fuzzy pinyin corresponding to the character “ [symbol] ”. Then, for pinyin “xing” of the character “ [symbol] ”, because the pinyin “xing” does not include any first pronunciation in Table 1, the pinyin “xing” is directly used as fuzzy pinyin corresponding to the character “ [symbol] ”. By analogy, for pinyin “lu” of the character “ [symbol] ”, because the pinyin “lu” includes the first pronunciation “l” in Table 1, the first pronunciation “l” in the pinyin is replaced with the second pronunciation “n” corresponding to the first pronunciation “l”, and pinyin “nu” obtained through replacement is used as fuzzy pinyin corresponding to the character “ [symbol] ”.

In this way, after processing in step 1051A to step 1055A, the obtained fuzzy pinyin corresponding to all the characters successively includes “ . . . zi xing che, . . . fa nu”.

Manner 2 is described below. To improve training efficiency and reduce training difficulty, in an embodiment of this specification, Manner 2 can be used. To be specific, pinyin is split into an initial and a final, whether the initial includes a first pronunciation and whether the final includes a first pronunciation are separately determined, and then fuzzy pinyin is replaced separately. In this case, step 105 specifically includes: Step 1051B: Split the pinyin of each character in the sample text into an initial and a final. Step 1053B: For the initial obtained through splitting, determine whether the initial includes a first pronunciation; and if no, directly use the initial as fuzzy pinyin corresponding to the initial of the character; or if yes, replace the first pronunciation in the initial with a second pronunciation corresponding to the first pronunciation, to obtain fuzzy pinyin corresponding to the initial of the character. Step 1055B: For the final obtained through splitting, determine whether the final includes a first pronunciation; and if no, directly use the final as fuzzy pinyin corresponding to the final of the character; or if yes, replace the first pronunciation in the final with a second pronunciation corresponding to the first pronunciation, to obtain fuzzy pinyin corresponding to the final of the character.

In an embodiment of this specification, to further improve training efficiency and reduce training difficulty, the final can further be simplified. In other words, a head vowel part in the final is deleted. For example, for pinyin “guang”, a final includes “uang”, and a head vowel “u” in the final has a relatively small contribution to a pronunciation of the pinyin “guang”, and a final “ang” has a relatively large contribution to a pronunciation of the pinyin “guang”, and is a key part of the pronunciation of the final. Therefore, to improve efficiency, impact of the head vowel on the pronunciation can be not considered in a training process. In this way, in step 1055B, before the determining whether the final includes a first pronunciation, the method further includes: determining whether the final includes a head vowel and a tail vowel, and if yes, deleting the head vowel from the final. Then, in step 1055B, whether a final after the head vowel is deleted includes a first pronunciation is determined; and if no, the final after the head vowel is deleted is directly used as the fuzzy pinyin corresponding to the final of the character; or if yes, the first pronunciation in the final after the head vowel is deleted is replaced with the second pronunciation corresponding to the first pronunciation, to obtain the fuzzy pinyin corresponding to the final of the character.

Next, in Step 107, the fuzzy pinyin recognition model is trained based on the sample text, the fuzzy pinyin corresponding to each character in the sample text, and the label of the sample text.

The above-mentioned example is still used for description. If Manner 1 is used in step 105, information input into the fuzzy pinyin recognition model in step 107 includes: “ . . . [symbol] (zi) [symbol] (xing) [symbol] (che) . . . , . . . [symbol] (fa) [symbol] (nu)” and the label of the sample text such as “traffic accident dispute”.

If Manner 2 is used in step 105, a specific implementation process of step 107 includes: Step 1071: Generate a triplet corresponding to each character in the sample text, where the triplet includes the character, the fuzzy pinyin corresponding to the initial of the character, and the fuzzy pinyin corresponding to the final of the character. Step 1073: Successively input triplets corresponding to all the characters and the label into the to-be-trained fuzzy pinyin recognition model in a sequence of all the characters in the sample text.

Manner 1 and Manner 2 are compared. Normally, there are 23 initials and 24 finals. When Manner 1 is used for an implementation, the fuzzy pinyin recognition model needs to learn of a total of 23*24 unknown pinyin syllables, to learn of the fuzzy pinyin. When Manner 2 is used for an implementation, the fuzzy pinyin recognition model needs to learn of a total of 23+24 unknown pinyin syllables, to learn of the fuzzy pinyin. It can be learned that, in Manner 2, training efficiency of the fuzzy pinyin recognition model can be greatly improved, and training difficulty can be reduced.

Regardless of whether Manner 1 or Manner 2 is used, the fuzzy pinyin recognition model has known from other characters in the training process that a pronunciation of “ [symbol] ” is “zi” and a pronunciation of “ [symbol] ” is “nu”. With reference to the context and the label of the sample text, the fuzzy pinyin recognition model can correct the sample text based on the input information, for example, as “ . . . [symbol] . . . , . . . [symbol] ”, to obtain a correct meaning.

It can be understood that the fuzzy pinyin recognition model is trained for a plurality of rounds, and is trained by using a plurality of sample texts. For a training process of each round, references can be made to the above-mentioned embodiments, until the fuzzy pinyin recognition model converges.

After training of the fuzzy pinyin recognition model is completed, the fuzzy pinyin recognition model can be used to understand a meaning of a speech.

The following describes the speech meaning understanding method in the second aspect.

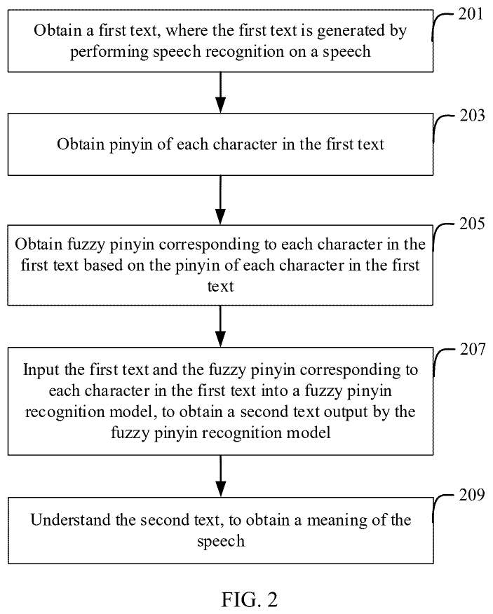

FIG. 2 is a flowchart illustrating a speech meaning understanding method, according to an embodiment of this specification. The method is performed by a speech meaning understanding apparatus. It can be understood that the method can alternatively be performed by any apparatus, device, platform, or device cluster having computing and processing capabilities. As shown in FIG. 2, the method includes step 201 to step 209.

Step 201: Obtain a first text, where the first text is generated by performing speech recognition on a speech.

Step 203: Obtain pinyin of each character in the first text.

Step 205: Obtain fuzzy pinyin corresponding to each character in the first text based on the pinyin of each character in the first text.

Step 207: Input the first text and the fuzzy pinyin corresponding to each character in the first text into a fuzzy pinyin recognition model, to obtain a second text output by the fuzzy pinyin recognition model. Step 209: Understand the second text, to obtain a meaning of the speech.

It can be learned that, in the process shown in FIG. 2, regardless of an accent or a pronunciation manner used by a user, two characters confused due to different pronunciations can be uniformly pronounced as the same fuzzy pinyin based on the fuzzy pinyin. In this way, with reference to a context of the first text, the fuzzy pinyin recognition model can obtain a character that is really required by a speech of the user, that is, obtain the second text that reflects real semantics, so that an error in the first text recognized from the speech can be corrected, and a machine can more accurately understand a meaning of the speech of the user based on the second text.

The following describes all steps shown in FIG. 2.

First, in step 201, the first text is obtained. The first text is generated by performing speech recognition on the speech.

Here, the first text is generated by performing speech recognition on the speech of the user in an actual application scenario. For example, the user enters a speech into an intelligent customer service system, and a speech recognition system recognizes the speech, to obtain the first text.

Next, in step 203, the pinyin of each character in the first text is obtained.

Here, the pinyin of each character in a dictionary can be searched for.

Next, in step 205, the fuzzy pinyin corresponding to each character in the first text is obtained based on the pinyin of each character in the first text.

Step 205 can also be implemented in the above-mentioned two manners of Manner 1 and Manner 2.

When Manner 1 is used, in an embodiment of this specification, an implementation process of step 205 includes: for the pinyin of each character in the first text, determining whether the pinyin includes a first pronunciation, where the first pronunciation satisfies that a second pronunciation is confused with the first pronunciation; and if no, directly using the pinyin as the fuzzy pinyin corresponding to the character; or if yes, replacing the first pronunciation in the pinyin with the second pronunciation, and using pinyin obtained through replacement as the fuzzy pinyin corresponding to the character.

When Manner 2 is used, in an embodiment of this specification, an implementation process of this step 205 includes: splitting the pinyin of each character in the first text into an initial and a final; for the initial obtained through splitting, determining whether the initial includes a first pronunciation; and if no, directly using the initial as fuzzy pinyin corresponding to the initial of the character; or if yes, replacing the first pronunciation in the initial with a second pronunciation corresponding to the first pronunciation, to obtain fuzzy pinyin corresponding to the initial of the character; and for the final obtained through splitting, determining whether the final includes a first pronunciation; and if no, directly using the final as fuzzy pinyin corresponding to the final of the character; or if yes, replacing the first pronunciation in the final with a second pronunciation corresponding to the first pronunciation, to obtain fuzzy pinyin corresponding to the final of the character.

When Manner 2 is used, for the final obtained through splitting, before the determining whether the final includes a first pronunciation, the method further includes: determining whether the final includes a head vowel and a tail vowel, and if yes, deleting the head vowel from the final; and the determining whether the final includes a first pronunciation includes: determining whether the final after the head vowel is deleted includes a first pronunciation.

For a specific implementation process of step 205, references can be made to all related descriptions of step 105. Processing ideas thereof are the same.

Next, in step 207, the first text and the fuzzy pinyin corresponding to each character in the first text are input into the fuzzy pinyin recognition model, to obtain the second text output by the fuzzy pinyin recognition model. When step 205 is implemented in Manner 2, a process of step 207 includes: generating a triplet corresponding to each character in the first text, where the triplet includes the character, the fuzzy pinyin corresponding to the initial of the character, and the fuzzy pinyin corresponding to the final of the character; and successively inputting triplets corresponding to all the characters into the to-be-trained fuzzy pinyin recognition model in a sequence of all the characters in the first text.

For related descriptions and understandings of step 207, references can be made to the above-mentioned related descriptions of step 107. Processing ideas thereof are the same.

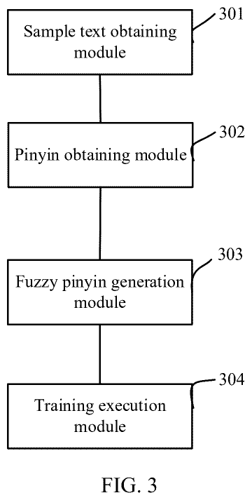

In an embodiment of this specification, a training apparatus for a fuzzy pinyin recognition model is provided. As shown in FIG. 3, the training apparatus includes: a sample text obtaining module 301, configured to obtain a sample text with semantics that includes a plurality of characters;

a pinyin obtaining module 302, configured to obtain pinyin of each character in the sample text; a fuzzy pinyin generation module 303, configured to obtain fuzzy pinyin corresponding to each character based on the pinyin of each character in the sample text; and a training execution module 304, configured to train the fuzzy pinyin recognition model based on the sample text, the fuzzy pinyin corresponding to each character in the sample text, and a label of the sample text.

In an embodiment of the apparatus in this specification, the fuzzy pinyin generation module 303 is configured to perform the following operations: for the pinyin of each character in the sample text, determining whether the pinyin includes a first pronunciation, where the first pronunciation satisfies that a second pronunciation is confused with the first pronunciation; and if no, directly using the pinyin as the fuzzy pinyin corresponding to the character; or if yes, replacing the first pronunciation in the pinyin with the second pronunciation, and using pinyin obtained through replacement as the fuzzy pinyin corresponding to the character.

In another embodiment of the apparatus in this specification, the fuzzy pinyin generation module 303 is configured to perform the following operations: splitting the pinyin of each character in the sample text into an initial and a final; for the initial obtained through splitting, determining whether the initial includes a first pronunciation; and if no, directly using the initial as fuzzy pinyin corresponding to the initial of the character; or if yes, replacing the first pronunciation in the initial with a second pronunciation corresponding to the first pronunciation, to obtain fuzzy pinyin corresponding to the initial of the character; and for the final obtained through splitting, determining whether the final includes a first pronunciation; and if no, directly using the final as fuzzy pinyin corresponding to the final of the character; or if yes, replacing the first pronunciation in the final with a second pronunciation corresponding to the first pronunciation, to obtain fuzzy pinyin corresponding to the final of the character.

In an embodiment of the apparatus in this specification, the fuzzy pinyin generation module 303 is configured to perform the following operations: for the final obtained through splitting, before the determining whether the final includes a first pronunciation, determining whether the final includes a head vowel and a tail vowel, and if yes, deleting the head vowel from the final; and determining whether a final after the head vowel is deleted includes a first pronunciation.

In an embodiment of the apparatus in this specification, the training execution module 304 is configured to: generate a triplet corresponding to each character in the sample text, where the triplet includes the character, the fuzzy pinyin corresponding to the initial of the character, and the fuzzy pinyin corresponding to the final of the character; and successively input triplets corresponding to all the characters and the label into the to-be-trained fuzzy pinyin recognition model in a sequence of all the characters in the sample text.

In an embodiment of the apparatus in this specification, the label of the sample text includes a label given in at least one of an emotion dimension, a field dimension, a subject matter dimension, and a text meaning dimension.

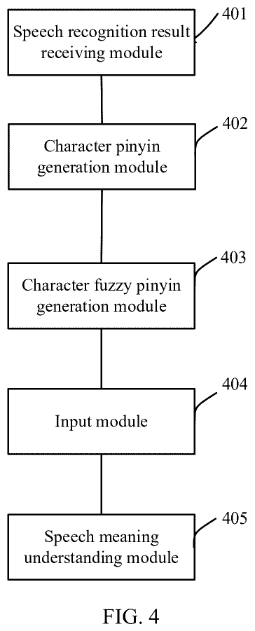

In an embodiment of this specification, a speech meaning understanding apparatus is provided. As shown in FIG. 4, the apparatus includes: a speech recognition result receiving module 401, configured to obtain a first text, where the first text is generated by performing speech recognition on a speech; a character pinyin generation module 402, configured to obtain pinyin of each character in the first text; a character fuzzy pinyin generation module 403, configured to obtain fuzzy pinyin corresponding to each character based on the pinyin of each character; an input module 404, configured to input the first text and the fuzzy pinyin corresponding to each character in the first text into a fuzzy pinyin recognition model, to obtain a second text output by the fuzzy pinyin recognition model; and a speech meaning understanding module 405, configured to understand the second text, to obtain a meaning of the speech.

In the speech meaning understanding apparatus in an embodiment of this specification, the character fuzzy pinyin generation module 403 is configured to perform the following operations: for the pinyin of each character in the first text, determining whether the pinyin includes a first pronunciation, where the first pronunciation satisfies that a second pronunciation is confused with the first pronunciation; and if no, directly using the pinyin as the fuzzy pinyin corresponding to the character; or if yes, replacing the first pronunciation in the pinyin with the second pronunciation, and using pinyin obtained through replacement as the fuzzy pinyin corresponding to the character.

In the speech meaning understanding apparatus in another embodiment of this specification, the character fuzzy pinyin generation module 403 is configured to perform the following operations: splitting the pinyin of each character in the first text into an initial and a final; for the initial obtained through splitting, determining whether the initial includes a first pronunciation; and if no, directly using the initial as fuzzy pinyin corresponding to the initial of the character; or if yes, replacing the first pronunciation in the initial with a second pronunciation corresponding to the first pronunciation, to obtain fuzzy pinyin corresponding to the initial of the character; and for the final obtained through splitting, determining whether the final includes a first pronunciation; and if no, directly using the final as fuzzy pinyin corresponding to the final of the character; or if yes, replacing the first pronunciation in the final with a second pronunciation corresponding to the first pronunciation, to obtain fuzzy pinyin corresponding to the final of the character.

In the speech meaning understanding apparatus in an embodiment of this specification, the character fuzzy pinyin generation module 403 is configured to perform the following operations: for the final obtained through splitting, before the determining whether the final includes a first pronunciation, determining whether the final includes a head vowel and a tail vowel, and if yes, deleting the head vowel from the final; and determining whether the final after the head vowel is deleted includes a first pronunciation.

In the speech meaning understanding apparatus in an embodiment of this specification, the input module 404 is configured to perform the following operations: generating a triplet corresponding to each character in the first text, where the triplet includes the character, the fuzzy pinyin corresponding to the initial of the character, and the fuzzy pinyin corresponding to the final of the character; and successively inputting triplets corresponding to all the characters into the fuzzy pinyin recognition model in a sequence of all the characters in the first text.

An embodiment of this specification provides a computer-readable storage medium. The computer-readable storage medium stores a computer program, and when the computer program is executed on a computer, the computer is enabled to perform the method according to any embodiment of this specification.

An embodiment of this specification provides a computing device, including a memory and a processor. The memory stores executable code, and when the processor executes the executable code, the method in any embodiment of this specification is implemented.

It can be understood that the structure illustrated in the embodiments of this specification does not constitute a specific limitation on the apparatus in the embodiments of this specification. In some other embodiments of this specification, the above-mentioned apparatus may include more or fewer components than those shown in the figure, or combine some components, or split some components, or have different component arrangements. The components in the figure can be implemented by hardware, software, or a combination of software and hardware.

Content such as information exchange and an execution process between the modules in the apparatus and the system is based on the same idea as the method embodiments of this specification. Therefore, for detailed content, references can be made to descriptions in the method embodiments of this specification, and details are not described here again.

The embodiments of this specification are described in a progressive way. For same or similar parts of the embodiments, mutual references can be made to the embodiments. Each embodiment focuses on a difference from other embodiments. Particularly, the apparatus embodiments are briefly described because they are basically similar to the method embodiments. For related parts, references can be made to related descriptions in the method embodiments.

A person skilled in the art should be aware that in the above-mentioned one or more examples, functions described in this disclosure can be implemented by hardware, software, firmware, or any combination thereof. When the functions are implemented by software, the above-mentioned functions can be stored in a computer-readable medium or transmitted as one or more instructions or code in the computer-readable medium.

In the above-mentioned specific implementations, the objectives, technical solutions, and beneficial effects of this disclosure are further described in detail. It should be understood that the above-mentioned descriptions are merely specific implementations of this disclosure, but are not intended to limit the protection scope of this disclosure. Any modification, equivalent replacement, improvement, etc. made based on the technical solutions of this disclosure shall fall within the protection scope of this disclosure.

1. A training method for a fuzzy pinyin recognition model, comprising:
obtaining a sample text with semantics that comprises a plurality of characters;
obtaining pinyin of each character in the sample text;
obtaining fuzzy pinyin corresponding to each character based on the pinyin of each character in the sample text; and
training the fuzzy pinyin recognition model based on the sample text, the fuzzy pinyin corresponding to each character in the sample text, and a label of the sample text.

2. The method according to claim 1, wherein obtaining fuzzy pinyin corresponding to each character based on the pinyin of each character in the sample text comprises:
for the pinyin of each character in the sample text, determining whether the pinyin comprises a first pronunciation, wherein the first pronunciation satisfies that a second pronunciation is confused with the first pronunciation; and
if no, directly using the pinyin as the fuzzy pinyin corresponding to the character; or
if yes, replacing the first pronunciation in the pinyin with the second pronunciation, and using pinyin obtained through replacement as the fuzzy pinyin corresponding to the character.

3. The method according to claim 1, wherein obtaining fuzzy pinyin corresponding to each character based on the pinyin of each character in the sample text comprises:
splitting the pinyin of each character in the sample text into an initial and a final;
for the initial obtained through splitting, determining whether the initial comprises a first pronunciation; and if no, directly using the initial as fuzzy pinyin corresponding to the initial of the character; or if yes, replacing the first pronunciation in the initial with a second pronunciation corresponding to the first pronunciation, to obtain fuzzy pinyin corresponding to the initial of the character; and
for the final obtained through splitting, determining whether the final comprises a first pronunciation; and if no, directly using the final as fuzzy pinyin corresponding to the final of the character; or if yes, replacing the first pronunciation in the final with a second pronunciation corresponding to the first pronunciation, to obtain fuzzy pinyin corresponding to the final of the character.

4. The method according to claim 3, wherein for the final obtained through splitting, before determining whether the final comprises a first pronunciation, the method further comprises: determining whether the final comprises a head vowel and a tail vowel, and if yes, deleting the head vowel from the final; and
determining whether the final comprises a first pronunciation comprises: determining whether a final after the head vowel is deleted comprises a first pronunciation.

5. The method according to claim 3, wherein training the fuzzy pinyin recognition model comprises:
generating a triplet corresponding to each character in the sample text, wherein the triplet comprises the character, the fuzzy pinyin corresponding to the initial of the character, and the fuzzy pinyin corresponding to the final of the character; and
successively inputting triplets corresponding to all the characters and the label into the to-be-trained fuzzy pinyin recognition model in a sequence of all the characters in the sample text.

6. The method according to claim 1, wherein the label of the sample text comprises a label given in at least one of an emotion dimension, a field dimension, a subject matter dimension, and a text meaning dimension.

7. A speech meaning understanding method, comprising:
obtaining a first text, wherein the first text is generated by performing speech recognition on a speech;
obtaining pinyin of each character in the first text;
obtaining fuzzy pinyin corresponding to each character based on the pinyin of each character;
inputting the first text and the fuzzy pinyin corresponding to each character in the first text into a fuzzy pinyin recognition model, to obtain a second text output by the fuzzy pinyin recognition model; and
understanding the second text, to obtain a meaning of the speech.

8. The method according to claim 7, wherein obtaining fuzzy pinyin corresponding to each character based on the pinyin of each character comprises:
for the pinyin of each character in the first text, determining whether the pinyin comprises a first pronunciation, wherein the first pronunciation satisfies that a second pronunciation is confused with the first pronunciation; and
if no, directly using the pinyin as the fuzzy pinyin corresponding to the character; or
if yes, replacing the first pronunciation in the pinyin with the second pronunciation, and using pinyin obtained through replacement as the fuzzy pinyin corresponding to the character.

9. The method according to claim 7, wherein obtaining fuzzy pinyin corresponding to each character based on the pinyin of each character comprises:
splitting the pinyin of each character in the first text into an initial and a final;
for the initial obtained through splitting, determining whether the initial comprises a first pronunciation; and if no, directly using the initial as fuzzy pinyin corresponding to the initial of the character; or if yes, replacing the first pronunciation in the initial with a second pronunciation corresponding to the first pronunciation, to obtain fuzzy pinyin corresponding to the initial of the character; and
for the final obtained through splitting, determining whether the final comprises a first pronunciation; and if no, directly using the final as fuzzy pinyin corresponding to the final of the character; or if yes, replacing the first pronunciation in the final with a second pronunciation corresponding to the first pronunciation, to obtain fuzzy pinyin corresponding to the final of the character.

10. The method according to claim 9, wherein for the final obtained through splitting, before determining whether the final comprises a first pronunciation, the method further comprises: determining whether the final comprises a head vowel and a tail vowel, and if yes, deleting the head vowel from the final; and
determining whether the final comprises a first pronunciation comprises: determining whether a final after the head vowel is deleted comprises a first pronunciation.

11. The method according to claim 9, wherein inputting the first text and the fuzzy pinyin corresponding to each character in the first text into a fuzzy pinyin recognition model comprises:
generating a triplet corresponding to each character in the first text, wherein the triplet comprises the character, the fuzzy pinyin corresponding to the initial of the character, and the fuzzy pinyin corresponding to the final of the character; and
successively inputting triplets corresponding to all the characters into the fuzzy pinyin recognition model in a sequence of all the characters in the first text.

12-14. (canceled)

15. A computing device, comprising a memory and a processor, wherein the memory stores executable instructions that, in response to execution by the processor, cause the computing device to:
obtain a sample text with semantics that comprises a plurality of characters;
obtain pinyin of each character in the sample text;
obtain fuzzy pinyin corresponding to each character based on the pinyin of each character in the sample text; and
train the fuzzy pinyin recognition model based on the sample text, the fuzzy pinyin corresponding to each character in the sample text, and a label of the sample text.

16. The computing device according to claim 15, wherein the computing device being caused to obtain fuzzy pinyin corresponding to each character based on the pinyin of each character in the sample text includes being caused to:
for the pinyin of each character in the sample text, determine whether the pinyin comprises a first pronunciation, wherein the first pronunciation satisfies that a second pronunciation is confused with the first pronunciation; and
if no, directly use the pinyin as the fuzzy pinyin corresponding to the character; or
if yes, replace the first pronunciation in the pinyin with the second pronunciation, and use pinyin obtained through replacement as the fuzzy pinyin corresponding to the character.

17. The computing device according to claim 15, wherein the computing device being caused to obtain fuzzy pinyin corresponding to each character based on the pinyin of each character in the sample text includes being caused to:
split the pinyin of each character in the sample text into an initial and a final;
for the initial obtained through splitting, determine whether the initial comprises a first pronunciation; and if no, directly use the initial as fuzzy pinyin corresponding to the initial of the character; or if yes, replace the first pronunciation in the initial with a second pronunciation corresponding to the first pronunciation, to obtain fuzzy pinyin corresponding to the initial of the character; and
for the final obtained through splitting, determine whether the final comprises a first pronunciation; and if no, directly use the final as fuzzy pinyin corresponding to the final of the character; or if yes, replace the first pronunciation in the final with a second pronunciation corresponding to the first pronunciation, to obtain fuzzy pinyin corresponding to the final of the character.

18. The computing device according to claim 17, wherein the computing device is further caused to:
determine whether the final comprises a head vowel and a tail vowel, and if yes, delete the head vowel from the final; and
the computing device be caused to determine whether the final comprises a first pronunciation includes being caused to:
determining whether a final after the head vowel is deleted comprises a first pronunciation.

19. The computing device according to claim 17, wherein the computing device being caused to train the fuzzy pinyin recognition model includes being caused to:
generate a triplet corresponding to each character in the sample text, wherein the triplet comprises the character, the fuzzy pinyin corresponding to the initial of the character, and the fuzzy pinyin corresponding to the final of the character; and
successively input triplets corresponding to all the characters and the label into the to-be-trained fuzzy pinyin recognition model in a sequence of all the characters in the sample text.

20. The computing device according to claim 15, wherein the label of the sample text comprises a label given in at least one of an emotion dimension, a field dimension, a subject matter dimension, and a text meaning dimension.
